(19) United States
(12) Patent Application Publication
(10) Pub. No.: US 2019/0390085 A1
(43) Pub. Date: Dec. 26, 2019

(54) METHOD OF TEMPORARILY PROTECTING A METAL SURFACE USING A PRESSURE-SENSITIVE ADHESIVE FILM

(71) Applicant: NOVACEL, Deville-Les-Rouen (FR)

(72) Inventors: Jean-Loup MASSON, Bois-Guillaume (FR); Farah DE FILIPPIS, Sotteville-Les- Rouen (FR); Fanny SCHAPMAN, Sahurs (FR); Julien BENARD, Deville-Les-Rouen (FR)

(21) Appl. No.: 16/562,834

(22) Filed: Sep. 6, 2019

Related U.S. Application Data
(63) Continuation of application No. 15/737,359, filed on Dec. 18, 2017.

(30) Foreign Application Priority Data
Jun. 24, 2015 (FR) 1555812

(51) Int. Cl. C09J 7/38; B23K 26/60; C09J 7/24; C09J 7/20; B23K 26/38; B23K 26/00

(52) U.S. Cl. CPC C09J 7/383; B23K 26/60; C09J 7/243; C09J 7/201; B23K 26/38; C09J 2407/00; C09J 2483/005; C09J 2423/166; C09J 2423/106; C09J 2423/046; C09J 2421/00; B23K 26/009

(57) ABSTRACT

A method for temporarily protecting a surface uses a pressure-sensitive adhesive film and reduces unwinding force when the film is unwound. The pressure-sensitive adhesive film that comprises a backing coated on one side with a rubber adhesive containing at least 5 wt % of tackifying resin, and on the other side with a silicone epoxy varnish.

The invention relates to the field of temporary surface protection. More particularly, the invention relates to a pressure-sensitive adhesive film having reduced unwinding noise.

### PRIOR ART

Pressure-sensitive surface protection films are now widely used. These films are notably used for protecting surfaces that may or may not be lacquered, metallic or nonmetallic, for example automobile bodies, or plastic sheet surfaces (PMMA, PVC, PC, PETg, etc.) or profiles, laminated surfaces, varnished surfaces, glass—coated or uncoated, carpet, etc. One of the requirements that surface protection films must meet is to leave a minimum of marks, soiling or residues of adhesive on the protected surfaces once the film is removed. This requires special formulations of films, adhesives, inks and varnishes, as well as particular methods of assembly of these components.

Pressure-sensitive surface protection films generally comprise a backing layer and an adhesive layer formed on the latter. They may be prepared by coating an adhesive in solvent phase, in aqueous phase, by a dry process (hot melt or warm melt) on the backing layer, or by co-extrusion of the backing layer and adhesive layer in a single operation. As examples, we may mention the films described in the following documents: EP-A-0 519 278; U.S. Pat. No. 5,925,456; FR-A-2 969 626; DE-A-10 2005 055 913.

Moreover, a surface protection film is often printed in order to allow the client to convey an advertising message or information about the material that is protected (direction for fitting, storage conditions etc.).

In the field of temporary surface protection, a varnish is generally used in the case of printed films. The ink is deposited on the film, dried, and then covered with varnish. In the same way as for glue, the film undergoes corona pretreatment to allow the ink to fix. The varnish serves above all to mask the corona treatment that is not covered with ink. In certain cases, the varnish also serves to protect the printed matter against abrasion, to reduce the unwinding forces or to reduce the unwinding noise.

Patent application DE 29609679 describes a separating film (of the “liner” type) for protecting buildings against damp, comprising a backing coated with an adhesive layer and a silicone coating with epoxy function, crosslinked cationically, facing the adhesive layer.

Patent application EP-A-1 918 344 describes a surface protection film intended for protecting optical devices comprising a layer of rubber-based pressure-sensitive adhesive, and a layer formed from an acrylic silicone grafted polymer, arranged on either side of a backing layer.

Patent application FR-A-2 967 365 describes a temporary protection film for metal surfaces that comprises a backing layer coated on one of its faces with an adhesive layer based on natural or synthetic rubber, and coated on the other face with a so-called “non-stick” layer based on acrylic modified silicone, such as a silicone marketed by the company Evonik under the trade name Tego®, and more especially a mixture of the products Tego® RC 711 and Tego® RC 902. However, these silicones comprise secondary hydroxyl groups that will interfere with the free functionalities of the adhesive, resulting in modification of the technical properties of the film such as increase in unwinding force over time. In the present case, the free secondary hydroxyl functions of the varnish would react with the isocyanate (or other crosslinking agent) contained in the adhesive (creation of covalent bonds between the adhesive and the varnish) once the varnish and the adhesive come into contact during winding of the rolls, which would make it impossible to unwind the rolls owing to an excessive unwinding force (an effect commonly called “blocking”). Therefore, contrary to what is stated, the films described in application FR-A-2 967 365 cannot be used for temporary protection of surfaces.

Moreover, a silicone/adhesive complex comprising a backing layer coated on one of its faces with an adhesive layer and on the other of its faces with a layer based on silicone is known from patent application WO 01/38450; this complex notably finds application in the field of adhesive protective papers, labels, decorative papers and adhesive tapes. Quite particularly in this last-mentioned application, the silicone-based coating and the adhesive coating are brought into contact during winding of the backing on itself.

Adhesive tapes having a composite structure comprising a first substrate coated with a first layer comprising the reaction product of an epoxypolysiloxane resin, and a second substrate coated with a layer comprising a second layer of a pressure-sensitive adhesive, the second substrate being attached to the surface of the first layer by means of said adhesive, are also known from patent application WO 94/28080. All the adhesives used in the examples are made of synthetic rubber; in these examples the epoxypolysiloxane resin is not crosslinked after application on the substrate. From reading the protocol, page 14, it is understood that the adhesive tapes have a width of about an inch (2.54 cm). Adhesive tapes of this kind are not suitable for protecting metal surfaces.

For temporary protection of bare metals, the rubber adhesives are used for their high adhesive power, as the protective films obtained from such adhesives, once applied on the surface, must withstand high stresses such as laser cutting, and they must not become detached during the process. However, the film must be stripped some months after the pause. These protective films comprise a backing layer coated on one of its faces with an adhesive rubber of high adhesiveness, and on the other face with a varnish (non-stick layer), intended to increase the “release” properties of the film, i.e. the ability of the adhesive layer to detach more or less easily from the film. These protective films are applied on the surface of bare metals at a speed from 10 m/min to more than 200 m/min (generally 150 m/min), continuously or plate by plate (so-called “stop and go” process). However, unwinding of the rolls of films based on adhesive rubber of high adhesiveness generates noise, which increases with the speed of unwinding of the protective films. The problem arises quite particularly with rolls of adhesive film suitable for protecting metal surfaces, with width greater than or equal to 1 m, and with a minimum length of 250 m (and up to 2500 m). This noise level, measured at a distance of about ⅔ meters, may easily exceed 110 dB, which requires special protective measures. In fact, although the pain threshold of sound is 130 dB, discomfort may be caused starting from 85 dB. The inventors found that this problem arises quite particularly when the rubber adhesive comprises at least 5 wt % (relative to the total weight of the adhesive) of one or more tackifying resins, and has a glass transition temperature above 230° K.

Moreover, it is desirable, from an economic viewpoint, to be able to prepare surface protection films based on rubber adhesive of high adhesiveness on a coating line. In this process, the backing layer is coated on one side with the ink and then the varnish, which must be photocured, and then on the other side with the rubber adhesive. When the films are wound on reels, the varnish and the rubber adhesive come into contact; depending on the degree of crosslinking of the varnish and the degree of drying of the adhesive, a reaction may take place between the varnish and the adhesive, which may block the unwinding of the rolls of film. It will be noted in this respect that the method of preparation of protective films described in patent applications EP-A-1 918 344 and FR-A-2 967 365 is not a line coating process.

It is therefore desirable to have films for temporary protection notably of metal surfaces, in which the adhesive layer is based on rubber adhesive, and unwinding of which, at high unwinding speeds, is accompanied by a reduced level of emission of sound (<85 dB). It is also desirable to be able to improve the efficiency of manufacture of such films, notably by the line coating technique.

### DESCRIPTION OF THE INVENTION

It has now been discovered, and this forms the basis of the invention, that it is possible to prepare a pressure-sensitive adhesive film for temporary surface protection, in which the adhesive layer is a rubber adhesive containing one or more tackifying resins, and which is characterized by a glass transition temperature (Tg) above 230° K and, once wound into a roll, unwinds with a sound level below 85 dB. It has also been found that said protective film can be manufactured by line coating.

Thus, according to a first aspect, the invention relates to a pressure-sensitive adhesive film for temporary protection of surfaces, notably metallic, which comprises:
a backing comprising at least one layer of polyolefin,
a rubber adhesive coated on one of the faces of the backing, and
a varnish based on epoxy-modified silicone coated on the other face of said backing,
   the rubber adhesive being characterized by a glass transition temperature (Tg) above 230° K and being obtained by mixing about 5 to 40 wt % (dry extract) of a formulation containing:
30 to 80 wt %, preferably from 35 to 75 wt %, of a natural rubber or of a mixture of natural rubber(s) and synthetic rubber(s);
5 to 60 wt %, preferably 20 to 60 wt %, more preferably 30 to 60 wt %, of one or more tackifying resins;
0 to 40 wt %, preferably 0 to 20 wt %, of a plasticizer, such as an oil;
0 to 6 wt %, preferably >0 to 6 wt %, preferably >0 to 4 wt %, more preferably from 0.05 to 4 wt %, of a crosslinking agent;
0 to 4 wt %, preferably 0 to 2 wt %, of one or more antiaging agent(s);
   in a hydrocarbon-containing solvent such as toluene, gasoline, hexane or a mixture of these solvents, it being understood that the sum of the various constituents of the formulation is equal to 100 wt %.

The backing of the pressure-sensitive adhesive film according to the invention comprises at least one layer of polyolefin, said polyolefin being selected from a radical low-density polyethylene, a linear polyethylene, a polypropylene, a copolymer of ethylene and propylene, or a mixture of these compounds. “Mixture of these compounds” means, in the sense of the present invention, a mixture of several polyolefins of the same type, or of one or more polyolefin(s) of a first type with one or more polyolefin(s) of one or more other types.

Advantageously, the radical low-density polyethylene (rLDPE) has a density, measured according to standard ASTM 01505, in the range from 0.910 to 0.930, and a melt flow index, measured according to standard ASTM D1238 (190° C./2.16 kg), in the range from 0.3 to 10 dg/min. Linear polyethylene (linear PE) is a copolymer of ethylene and of a C₃-C₈ olefinic monomer, such as propene, butene, hexene, methylpentene or octene. Advantageously, the linear PE has a density, measured according to standard ASTM D1505, in the range from 0.858 to 0.961 and a melt flow index, measured according to standard ASTM D1238 (190° C./2.16 kg), in the range from 0.05 to 10 dg/min. The ethylene/propylene copolymer (EPM) advantageously has a density, measured according to standard ASTM D1505, in the range from 0.860 to 0.910 and a level of propylene in the range from 25 to 60 wt %.

The aforementioned rLDPE, linear PE and EPM may equally be from metallocene or Ziegler-Natty catalysis.

Advantageously, the polypropylene has a density, measured according to standard ASTM D1505, in the range from 0.860 to 0.920, and a melt flow index, measured according to standard ASTM D1238 (230° C./2.16 kg), in the range from 0.3 to 10 dg/min.

The backing of the pressure-sensitive adhesive film according to the invention is of the monolayer type or multilayer type, preferably the backing is multilayer and advantageously comprises 3, 5, 7 or 9 layers.

According to one embodiment of the invention, the backing is of the monolayer type, which consists essentially of polyolefin as defined above. “Consists essentially of” means that the layer of the backing does not comprise other constituents that may affect the mechanical and adhesive properties of the protective film. The layer may nevertheless contain one or more additives commonly used in the manufacture of pressure-sensitive adhesive films, selected for example from flatting agents, in particular antiblocking agents; glidants; colorants; UV stabilizers; UV barriers; antioxidants; antiaging agents.

According to another embodiment of the invention, the backing is of the multilayer type, and preferably comprises 3, 5, 7 or 9 layers. In this embodiment, one or more layers of the backing consist essentially of polyolefin (and may each comprise, as stated above, one or more conventional additives). Advantageously, the number of layers of the backing is an odd number, and the middle layer consists essentially of polyolefin. The layers of the backing other than the middle layer advantageously consist essentially of (1) a polyolefin, (2) a synthetic rubber, (3) a copolymer of ethylene and vinyl acetate, or a mixture of these compounds. The expression “consisting essentially of” used here has the same meaning as before. “Mixture of these compounds” means a mixture of several compounds of the same type [(1), (2) or (3)], or of one or more compounds of a first type with one or more compounds of one or more other types.

The polyolefin used for the layers other than the middle layer is advantageously selected from a radical polyethylene (PE), a linear polyethylene (PE), a polypropylene (PP) or an ethylene/propylene copolymer (EPM).

The radical PE advantageously has a density, measured according to standard ASTM D1505, in the range from 0.910 to 0.930, and a melt flow index, measured according to standard ASTM D1238 (190° C./2.16 kg), in the range from 0.3 to 10 dg/min. The linear PE is a copolymer of ethylene and a C₃-C₈ olefinic monomer, such as propene, butene, hexene, methylpentene or octene. It may be of high, medium, low or very low density, i.e. with a density, measured according to standard ASTM D1505, in the range from 0.858 to 0.961, and a melt flow index, measured according to standard ASTM D1238 (190° C./2.16 kg), in the range from 0.05 to 10 dg/min. All the aforementioned polyethylenes may equally be from metallocene or Ziegler-Natta catalysis.

The PP has a density, measured according to standard ASTM D1505, advantageously in the range from 0.860 to 0.920, and a melt flow index, measured according to standard ASTM D1238 (230° C./2.16 kg), in the range from 0.3 to 10.

The EPM has a density, measured according to standard ASTM D1505, advantageously in the range from 0.860 to 0.910 and a level of propylene in the range from 25 to 60 wt %. The PP and the EPM may equally be from metallocene or Ziegler-Natta catalysis.

The synthetic rubber that can be used in the layers other than the middle layer is advantageously selected from a styrene-ethylene-butylene-styrene copolymer (SEBS); a styrene-ethylene-propylene-styrene copolymer (SEPS); a styrene-isoprene-styrene copolymer (SIS); an asymmetric SIS, a vinyl derivative, hydrogenated or not, of SIS; a styrene-isoprene-butadiene-styrene copolymer (SIBS); a styrene-isobutylene-styrene copolymer (SIBS); an ethylene-styrene copolymer (ES); and mixtures of these copolymers.

The SEBS, SEPS, SIS, SIBS and SiBS advantageously have a level of styrene less than or equal to 50 wt %, preferably in the range from 5 to 45 wt %; also advantageously, these polymers have a level of SEB, SEP, SI, SIB or SiB diblocks less than or equal to 70 wt %. The ES advantageously have a level of styrene in the range from 5 to 85 wt %, and preferably a melt flow index, measured according to standard ASTM 1238, in the range from 0.1 to 40 dg/min.

The copolymer of ethylene and vinyl acetate (EVA) that can be used in the layers other than the middle layer advantageously has a level of vinyl acetate less than or equal to 80 wt %, and a melt flow index, measured according to standard ASTM D1238, in the range from 0.1 to 40 dg/min.

Each layer of the backing may contain one or more additives such as flatting agents, notably antiblocking agents; glidants; colorants; UV stabilizers; UV barriers; antioxidants; antiaging agents; additives modifying the level of adherence of the layer. These additives, when present, represent about 0.1 to about 25 wt % of the total weight of each layer. Additives that are particularly advantageous in the context of the present invention are flatting agents, antioxidants (primary or secondary) and antiaging agents.

Among the flatting agents, we may mention:
the flatting agents that are incompatible with the low density PEs, such as the acrylic grafted polyethylenes or the polyethylene salts;
the antiblocking agents, such as silica and derivatives thereof, talc and derivatives thereof, mica and derivatives thereof.

Among the antiaging agents, we may mention the sterically hindered amines, also called MALS (“Hindered Amine Light Stabilizers”).

It is possible to use several additives of the same type.

The backing used in the context of the invention may be prepared by extrusion of the layer or layers of which it is constituted, in particular by cast film co-extrusion or blown film co-extrusion. These techniques are familiar to a person skilled in the art, and are described for example in the work “Encyclopedia of Chemical Technology” (Kirk-Othmer), 1996, volume 19, pages 290-316.

The backing of the pressure-sensitive adhesive film according to the invention is coated, on one of its faces, with a varnish forming a “non-stick” layer.

The varnish that can be used in the context of the invention is based on silicone resin modified by epoxy functions, and advantageously comprises:
100 parts by weight of silicone epoxy resin;
0-150 parts by weight of an adherence modulating system;
0-20 parts by weight, preferably >0-20 parts by weight, more preferably from 0.5 to 20 parts by weight, more preferably from 1 to 10 parts by weight, of a cationic photoinitiator;
0-20 parts by weight of one or more additives selected from an antifoaming agent and fillers that improve sliding, abrasion resistance, and/or bonding of the varnish on the backing film.

As examples of silicone epoxy resin that can be used in the context of the invention, we may mention those described in patent application WO 2007/031539, which comprise

polyorganosiloxanes consisting of units of formula (II) and optionally (III) and terminated with units of formula (I) or cyclic polyorganosiloxanes consisting of units of formula (II) shown below (obtained from patent WO/031539):

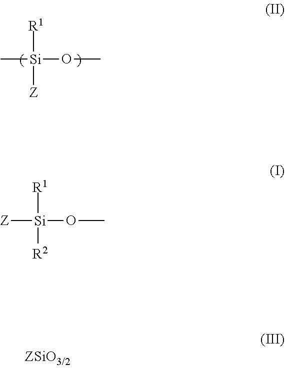

in which:
the symbols R¹ and R² are similar or different and represent:
   a linear or branched alkyl radical containing 1 to 8 carbon atoms, optionally substituted with at least one halogen, preferably fluorine,
   a cycloalkyl radical containing from 5 to 8 carbon atoms, optionally substituted,
   an aryl radical containing from 6 to 12 carbon atoms, optionally substituted, preferably phenyl or dichlorophenyl,
   an aralkyl moiety having an alkyl moiety containing from 5 to 14 carbon atoms and an aryl moiety containing from 6 to 12 carbon atoms, optionally substituted on the aryl moiety with halogens, alkyls and/or alkoxyls containing from 1 to 3 carbon atoms,
the symbols Z are similar or different and represent:
   a group R¹ and/or R²,
   a hydrogen radical,
   and/or a crosslinkable organofunctional group, preferably a functional epoxy group, functional acrylate group, functional oxetane group and/or functional dioxolane group or functional alkenyl ether group, joined to the silicon of the polyorganosiloxane via a divalent radical containing from 2 to 20 carbon atoms and that may contain at least one heteroatom, preferably oxygen,
   with at least one of the symbols Z representing a crosslinkable functional organic group.

We may also mention, as examples of silicone epoxy resin that can be used in the context of the invention, those described in patent application WO 02/42388 (“silicone B”), or else those marketed by the company Bluestar Silicones under the name SILCOLEASE® UV 200 (“polymers” range).

The adherence modulating system included in the varnish used in the context of the invention will allow controlled detachment of the adhesive (rubber adhesive) when the roll of film is unwound. The adherence modulators may be silicone resins or linear polymers bearing vinyl, epoxy, vinyl ether functions, etc. The reactive groups will allow the resins of the modulator to bind to the silicone “network”. These additives are described for example in patent application FR-A-2 825 713.

As examples of adherence modulating system that can be used in the context of the invention, we may mention the products marketed by the company Bluestar Silicones under the name SILCOLEASE® UV 200 (“release control additives” range).

Light-activated polymerization and/or crosslinking is generally initiated in the presence of a photoinitiator incorporated in the silicone matrix. The initiator used, generally a cationic photoinitiator, releases a strong acid under irradiation. The latter catalyzes the cationic polymerization reaction of the functional groups. It is to be understood that any cationic photoinitiator active under UV may be suitable according to the invention. As examples of photoinitiator that can be used in the context of the invention, we may mention the onium salts and in particular those described in patents U.S. Pat. Nos. 4,026,705, 4,032,673, 4,069,056, 4,136,102, 4,173,476 and in patent application EP-A-562 897, the products marketed by the company Evonik under the name TEGO® PC, or the products marketed by the company Bluestar Silicones under the name SILCOLEASE® UV 200® (“catalysts and additives” range).

In one embodiment of the invention, the varnish comprises one or more silicone epoxy resins and one or more adherence modulating systems, in the respective proportions mentioned above.

Preferably, the varnish is coated on one of the faces of the backing at a rate from about 0.1 to about 5 g/m² of area treated. These amounts obviously depend on the nature of the backing and the required release properties. Even more preferably, the amount of varnish deposited on the backing is from about 0.4 to about 2.5 g/m², in particular from about 0.5 to about 1.5 g/m².

Preferably, the backing is plasma or corona treated before application of the varnish.

The varnish is applied on the backing layer using well-known coating techniques, for example, as a guide, the technologies of gravure coating, direct or indirect (porous metering roll), curtain coating, or slot die coating, flexographic coating, or by multiroll coater (for example four, five or six rolls). Then the varnish is crosslinked by cationic photopolymerization under ionizing radiation. This photopolymerization technique offers the advantage, relative to the technique of thermal polymerization or radical photopolymerization, of not requiring solvents (economic and environmental advantage), or inert gas (environmental advantage as less waste, and ease of use).

Once the varnish is crosslinked, the rubber adhesive as defined above is applied on the other face of the backing, by means of a coater positioned in series.

The natural rubber used in the rubber adhesive may be from any country that produces natural rubber, for example Thailand, Indonesia, Malaysia, India, Vietnam, China or West Africa. The TSR grades (Technical specification of rubber) may be for example 5L, 5, 10, 20 and 50 or the CV grades (“Viscosity Stabilized”), such as LV 45, CV 50, LV 55 or CV 55, LV 60 or CV 60, LV 65 or CV 65, or CV 70, which may or may not have undergone one or more cycles of mastication.

The rubber or elastomer components are selected so as to give a rubber mix having a Mooney index from 20 to 80 according to standard NF ISO 289-1, and preferably from 30 to 60.

The synthetic rubber usable in the rubber adhesive is advantageously selected from a synthetic polyisoprene (PI), a styrene-butadiene (SBR), an isobutylene-isoprene copolymer (IIR: isobutylene isoprene rubber), a styrene-ethylene-butylene-styrene copolymer (SEBS); a styrene-ethylene-propylene-styrene copolymer (SEPS); a styrene-butadiene-styrene copolymer (SBS); a styrene-isoprene-styrene copolymer (SIS); an asymmetric SIS, a vinyl derivative, hydrogenated or not, of SIS; a styrene-isoprene-butadiene-styrene copolymer (SIBS); a styrene-isobutylene-styrene copolymer (SiBS); an ethylene-styrene copolymer (ES); and mixtures of these copolymers with or without natural rubber.

When the rubber adhesive comprises a mixture of natural rubber(s) and synthetic rubber(s), the natural rubber(s) represent at least 50 wt %, for example at least 60 wt %, at least 70 wt %, or at least 80 wt %, of the total weight of the adhesive.

The tackifying resin used in the rubber adhesive is advantageously a thermoplastic resin, of low molecular weight, natural or synthetic, or nonhydrogenated, fully or partially hydrogenated or mixed, preferably of C5 or C9 or a C5/C9 mixture, a cyclic diolefin (C5)₂, or a rosin derivative (polymerized, hydrogenated, esterified or disproportionated rosin).

The plasticizer usable in the rubber adhesive is advantageously a plasticizer oil or a plasticizer resin preferably of a weakly polar nature, suitable for plasticizing elastomers, notably thermoplastics. At room temperature (23° C.), these oils, of variable viscosity, are liquid. For example, the plasticizer oil is selected from the group consisting of the paraffinic, naphthenic, or aromatic oils.

The antiaging agent usable in the rubber adhesive is as defined above.

Advantageously, the crosslinking agent used in the rubber adhesive of the invention is an isocyanate crosslinking agent, notably an aliphatic isocyanate crosslinking agent or an alicyclic isocyanate crosslinking agent. As examples of aliphatic isocyanate crosslinking agent, we may mention an aliphatic diisocyanate, such as hexamethylene diisocyanate; a trimer of such a diisocyanate; an aliphatic triisocyanate; as well as a polymer obtained from these homo- or copolymerized monomers, or from the addition of a polyol or of a polyamine with one or more of these monomers, the polyol or the polyamine being a polyether, a polyester, a polycarbonate, or a polyacrylate. As examples of alicyclic crosslinking agent that can be used in the context of the invention, we may mention an alicyclic diisocyanate, such as 3-isocyanatomethyl-3,5,5-trimethylcyclohexyl isocyanate (better known as isophorone diisocyanate or IPDI) or hydrogenated diphenylmethane diisocyanate; a trimer of such a diisocyanate; an alicyclic triisocyanate; as well as a polymer obtained from these homo- or copolymerized monomers, or from the addition of a polyol or of a polyamine with one or more of these monomers, the polyol or the polyamine being a polyether, a polyester, a polycarbonate, or a polyacrylate.

Other classes of crosslinking agents may also be used advantageously. As examples, we may mention the polyaziridines, the polycarbodiimides or the aluminum salts.

In one embodiment of the invention, several layers of rubber adhesive are applied; it goes without saying that in this instance at least one of the layers contains a crosslinking agent.

When the rubber adhesive does not contain a crosslinking agent, the backing is coated with a layer of bonding primer, typically with a thickness of about 1 μm, prior to application of said adhesive.

Other additives may be used, such as flame retardants, fillers (talc, calcium carbonate, etc.), colorants, etc.

The rubber adhesive used in the context of the present invention has an elastic modulus G′ which, measured at 1 Hz over a temperature range from 0° C. to 50° C., has values less than or equal to 3.10⁵ Pa, preferably less than or equal to 10⁵ Pa, more preferably less than or equal to 8.10⁴ Pa. Measurement of the elastic modulus G′ is performed according to standard ISO 6721-1. Said measurement may be performed using an imposed-deformation rheometer such as the apparatus marketed under the name RDA II by the company RHEOMETRIC SCIENTIFIC (TA INSTRUMENT). The expression “elastic modulus G′ which, measured at 1 Hz over a temperature range from 0° C. to 50° C., has values less than or equal to 3.10⁵ Pa” means, as is well known by a person skilled in the art, that G′ has the required values over at least part of the aforementioned temperature range, for example at 0° C., 10° C., 20° C., 30° C., 40° C. and/or 50° C.

The adhesive is advantageously coated on the backing, in one or more layers, at a rate from about 0.5 to about 25 g/m², preferably at a rate from about 0.5 to about 20 g/m², more preferably at a rate from about 2 to about 20 g/m².

Preferably, the backing is plasma or corona treated before application of the adhesive. Application of the adhesive is carried out using the coating techniques described above for the varnish, to which specific technologies for coating solvent-based rubber adhesives may be added, such as “kiss-coat” or “roll-over-roll” coating.

According to one embodiment of the invention, the pressure-sensitive adhesive film may comprise patterns printed on the backing of the film (prior to coating of the varnish and of the adhesive). The ink usable for printing may be a solvent-based ink (gasoline, toluene, ethyl acetate etc.), water, or else solvent-free and UV or electron-beam crosslinkable.

The inks mainly consist of resins or of a mixture of resins, which may be cellulosic (for example nitrocellulosic of ethylcellulose, cellulose acetobutyrate or acetopropionate) alkyds, polyester, polyurethanes, maleic, polyamides, vinylic, acrylic, ketonic, epoxide, unsaturated polyesters, polyols whether or not acrylated, epoxy resins, phenoxides, vinyl ethers etc.

Preferably, the backing is plasma or corona treated before application of the ink. The ink is applied on the backing by well-known coating techniques. We may mention, as nonlimiting examples, the technologies of coating by flexography, screen printing, heliography, offset, jet printing, etc.

The amounts of ink most often range between about 0.1 and about 5 g/m². Most often they are between about 0.5 and about 13 g/m². The pressure-sensitive adhesive film thus obtained has a thickness generally between about 20 μm and about 150 μm, preferably between about 20 μm and about 110 μm. The backing generally represents between 60% and 95% of the total thickness of the film.

The pressure-sensitive adhesive film according to the invention has, before application on a surface to be protected, a detaching force, measured according to standard AFERA 5001 (peeling at 180° and peeling speed of 300 mm/min), in the range from 40 to 400 cN/cm. After application on the surface to be protected, the protective film has a detaching force (measured by dynamometry according to a protocol adapted from standard AFERA 5001, with a peeling speed of 300 mm/min) in the range from 20 to 600 cN/cm, preferably from 50 to 400 cN/cm.

The pressure-sensitive adhesive film according to the invention is therefore particularly suitable for temporary protection of surfaces, notably temporary protection of bare or painted metal surfaces, plastic sheets, laminates, carpets, plastic profiles, varnished plastic surfaces, and glass. It is typically wound into rolls with a width between 950 mm and 2700 mm, and a length between 250 m and 2500 m. Said pressure-sensitive adhesive film notably has the following technical advantages:
it is environmentally friendly (no solvent used during coating of the varnish on the backing);
it unwinds with less noise relative to products with the same thickness and the same weight of adhesive: the unwinding noise (measured between 0 and 200 m/min) is below 85 dB, which meets the criterion established in European Directive No. 2003/10/EC relating to protection of workers exposed to noise.

It is known that the reaction of polymerization of a varnish by cationic photocrosslinking takes longer than polymerization by radical photocrosslinking. It was therefore to be expected that, owing to incomplete crosslinking of the varnish at the time of combining it in series with the adhesive, the latter would react or interpenetrate with the rubber adhesive, which itself is reactive through its crosslinking agent, when the film is wound into a roll, and causes contamination or a blocking effect during unwinding of the film, making the film unusable for surface protection. Now, against all expectation, it was found that crosslinking the varnish by cationic photopolymerization does not adversely affect good cohesion of the varnish and bonding of the varnish on the back of the film, does not cause contamination with respect to the adhesive and does not give rise to a reaction between the two systems (adhesive and varnish), which allows line coating of the cationically crosslinkable varnish and the reactive adhesive.

According to another aspect, the invention relates to the use of the pressure-sensitive adhesive film according to the invention for temporary protection of surfaces, notably metallic, whether bare or painted.

According to another aspect, the invention relates to a method for temporary protection of a bare or painted metal surface, which consists of applying a pressure-sensitive adhesive film as defined above on said surface.

According to another aspect, the invention also relates to a method for laser beam cutting or piercing of a metal sheet, which comprises a step of protecting said metal sheet with a pressure-sensitive adhesive film according to the invention. In one embodiment of this aspect of the invention, the sheet is a sheet of steel, notably of stainless steel, or a sheet of aluminum or aluminum alloy or of copper or of brass.

The invention is illustrated by the following examples, given purely as a guide.

### Example 1: Adhesive Film Consisting of a Rubber-Coated Three-Layer Backing

A black/white film with a thickness of 87 μm was prepared using equipment for three-layer blown film co-extrusion. Thus, the following were introduced:
in extruder No. 1, a 90/10 mixture by weight of radical polyethylene with a density of 0.924 and a melt flow index of 0.7 and an antiblocking masterbatch ABPE 50N (Polytechs);
in extruder No. 2, an 82/16/2 mixture by weight of radical polyethylene with a density of 0.924 and a melt flow index of 0.7, a white colorant (TiO₂), CL8000 (A. Schulman), and Polybatch UV1952 antioxidant (A. Schulman); and
in extruder No. 3, an 86/12/2 mixture by weight of radical polyethylene with a density of 0.924 and a melt flow index of 0.7, a black colorant (carbon black), 1423HF1 (A. Schulman), and an antiblocking masterbatch ABPE 5ON (Polytechs).

An extrusion aid, the “processing aids” masterbatch POLYBATCH® NATURAL AMF 705 HF (A. Schulman), was used in order to facilitate extrusion.

The extruded film thus obtained has a thickness of 87 μm, and a gloss of 50 measured according to standard ASTM2457. The surfaces intended to be in contact with the adhesive layer and the varnish layer were then corona treated.

In addition, an adhesive composition was prepared by mixing, in gasoline:
43 wt % of natural rubber (Mooney viscosity 45);
52 wt % of tackifying resin C5;
1.5 wt % of antioxidant;
0.5 wt % of antiaging agent;
3 wt % of isocyanate crosslinking agent;
   the composition thus obtained having a Tg of 250° K, determined by dynamic mechanical analysis (DMA, ARES system in plate-plate mode, with temperature sweep from −193° K to 423° K with a temperature ramp of 5° K/min).

A varnish composition was also prepared by mixing:
50 parts by weight of poly 200 (Bluestar Silicones),
50 parts by weight of the agent Control Release RCA 251 (Bluestar Silicones),
3 parts by weight of cata 211 photoinitiator (Bluestar Silicones).

The varnish composition was line coated at 100 m/min on one of the faces of the backing film in the normal conditions familiar to a person skilled in the art, and crosslinked using a 200 W/cm mercury lamp, to obtain a dry deposit of 0.8 g/m², equivalent to a thickness of 0.8 microns. Then the adhesive composition was coated, still in line, on the other face of the backing film in the normal conditions familiar to a person skilled in the art, to obtain a dry deposit of 12 g/m², equivalent to a thickness of 12 microns.

### Comparative Example 1: Adhesive Film Consisting of a Rubber-Coated Three-Layer Backing

The protocol of example 1 was repeated but using a composition of the polyvinyl octadecyl carbamate type as the varnish, to obtain a dry deposit of 0.05 g/m².

### Example 2: Adhesive Film Consisting of a Rubber-Coated Three-Layer Backing

The protocol of example 1 was repeated but using the following varnish composition:
90 parts by weight of poly 200 (Bluestar Silicones),
10 parts by weight of the agent Control Release RCA 251 (Bluestar Silicones),
3 parts by weight of cata 211 photoinitiator (Bluestar Silicones).

As in example 1, the varnish composition was line coated at 100 m/min, on one of the faces of the backing film in the normal conditions familiar to a person skilled in the art, and crosslinked using a 200 W/cm mercury lamp, to obtain a dry deposit of 0.8 g/m², equivalent to a thickness of 0.8 microns.

The properties of the films in examples 1 and 2 and comparative example 1 are presented in Table 1.

TABLE 1

| | Example 1 | Example 2 | Comp. Ex. 1 |
|---|---|---|---|
| Deposit (g/m²) | 0.8 | 0.8 | 0.05 |
| Noise (dB) at 100 m/min on | 81.5 | 83.5 | 95.5 |
| 1000 mm width | | | |
| Detaching force on back | 114 | 121 | 109 |
| (cN/cm) | | | |
| PAL/A 5001 (cN/cm) | 97 | 91 | 84 |
| Detaching force on Stainless | 184 | 182 | 183 |
| steel 2B (cN/cm) | | | |

The pressure-sensitive adhesive films according to the invention have an initial detaching force on their back comparable to the control (measured with a dynamometer of the Instron type at 300 mm/min and 180°, protocol adapted from standard AFERA 5001: application of the test film on a sample of film back, the sample is then left under a controlled atmosphere for 1 h before measurement). The results obtained show that there was no contamination of the adhesive by the varnish.

The pressure-sensitive adhesive films according to the invention also have an initial detaching force on stainless steel 2B comparable to the control (measured with a dynamometer of the Instron type at 300 mm/min and 180°, protocol adapted from standard AFERA 5001: application of the test film on a stainless steel plate by means of a calender, the plate is then left under a controlled atmosphere for 1 h before measurement). The pressure-sensitive adhesive films according to the invention also have a PAL/A detaching force (measured with a dynamometer of the Instron type at 300 mm/min and 180°, according to the protocol of standard AFERA 5001) that is comparable to the control. The results obtained confirm that there was no contamination of the adhesive by the varnish.

The noise during unwinding of the rolls was measured at an unwinding speed of 100 m/min (roll with 1000 mm width) using a CIRRUS Optimus CR 162C sound-level meter. A marked reduction in noise is found for the films according to the invention: less than 85 dB for the adhesive film of examples 1 and 2 against more than 95 dB for the control roll (comparative example 1).

### Example 3: Adhesive Film Consisting of a Rubber-Coated Three-Layer Backing

A black/white film with a thickness of 87 μm was prepared using equipment for three-layer blown film co-extrusion. Thus, the following were introduced:
in extruder No. 1, a 98/2 mixture by weight of radical polyethylene with a density of 0.924 and a melt flow index of 0.7 and an antiblocking masterbatch ABPE 50N (Polytechs);
in extruder No. 2, an 82/16/2 mixture by weight of radical polyethylene with a density of 0.924 and a melt flow index of 0.7, a white colorant (TiO₂), CL8000 (A. Schulman), and Polybatch UV1952 antioxidant (A. Schulman); and
in extruder No. 3, an 86/12/2 mixture by weight of radical polyethylene with a density of 0.924 and a melt flow index of 0.7, a black colorant (carbon black), 1423HF1 (A. Schulman), and an antiblocking masterbatch ABPE 50N (Polytechs).

An extrusion aid, the “processing aids” masterbatch POLYBATCH® NATURAL AMF 705 HF (A. Schulman), was used in order to facilitate extrusion.

The extruded film thus obtained has a thickness of 87 μm and a gloss of 67 measured according to standard ASTM2457. The surfaces intended to be in contact with the adhesive layer and the varnish layer were then corona treated.

The protocol of example 2 was repeated but coating, still in line, the outer face of the film with a blue nitrocellulose ink at 0.8 g/m² by flexography, prior to application of the varnish, which was then crosslinked under UV so as to obtain a dry deposit of 2.5 g/m², equivalent to a thickness of 2.5 microns.

### Comparative Example 3: Adhesive Film Consisting of a Rubber-Coated Three-Layer Backing

The protocol of example 3 was repeated, but using a composition of the polyvinyl octadecyl carbamate type as the varnish, to obtain a dry deposit of 0.05 g/m², equivalent to a thickness of 0.05 micron.

The properties of the films of example 3 and comparative example 3 are presented in Table 2.

TABLE 2

| | Example 3 | Comp. Ex. 3 |
|---|---|---|
| Deposit (g/m²) | 2.5 | 0.05 |
| Noise (dB) at 100 m/min on | 77.5 | 113 |
| 200 mm width | | |
| Unwinding force at 100 m/min | 16 | 100 |
| (cN/cm) | | |
| PAL/A 5001 (cN/cm) | 149 | 138 |
| Detaching force on | 190 | 200 |
| Stainless steel 2B (cN/cm) | | |

The pressure-sensitive adhesive film of example 3 has an initial unwinding force at 100 m/min that is greatly improved relative to the control (measurement at 100 m/min by means of the Lefebure “Unwinding force” equipment with FN 3148 No. 1294 sensor and M210 No. 833 indicator of the electronic type inspired by European standard NF EN 12026).

The pressure-sensitive adhesive film of example 3 has an initial detaching force on Stainless steel 2B and a PAL/A 5001 comparable to the control (measurement as indicated in example 2). The results obtained show that there was no contamination of the adhesive by the varnish.

The noise during unwinding of the rolls was measured at an unwinding speed of 100 m/min (roll with 200 mm width) using a CIRRUS Optimus CR 162C sound-level meter. A marked reduction in noise is found for the film according to the invention: less than 80 dB for the adhesive film of example 3 against more than 110 dB for the control roll (comparative example 3).

### Example 4: Adhesive Film Consisting of a Rubber-Coated Three-Layer Backing

A colorless film with a thickness of 54 μm was prepared using equipment for three-layer blown film co-extrusion. Thus, the following were introduced:
in extruder No. 1, a 98/2 mixture by weight of radical polyethylene with a density of 0.924 and a melt flow index of 0.7 and an antiblocking masterbatch ABPE 50N

(Polytechs);
in extruder No. 2, a 98/2 mixture by weight of radical polyethylene with a density of 0.924 and a melt flow index of 0.7, and Polybatch UV1952 antioxidant (A. Schulman); and
in extruder No. 3, a 98/2 mixture by weight of radical polyethylene with a density of 0.924 and a melt flow index of 0.7, and an antiblocking masterbatch ABPE 50N (Polytechs).

An extrusion aid, the “processing aids” masterbatch POLYRATCH® NATURAL AMF 705 HF (A. Schulman), was used in order to facilitate extrusion.

The extruded film thus obtained has a thickness of 54 μm and a gloss of 75 as measured according to standard ASTM2457. The surfaces intended to be in contact with the adhesive layer and the varnish layer were then corona treated.

In addition, an adhesive composition was prepared by mixing, in gasoline:
48 wt % of natural rubber (Mooney viscosity 45),
33 wt % of tackifying resin C5,
12 wt % of a paraffin oil as plasticizer,
1.5 wt % of antioxidant,
1.5 wt % of antiaging agent,
4 wt % of isocyanate crosslinking agent,
   the composition thus obtained having a glass transition temperature equal to 251° K, determined by DMA (ARES system in plate-plate mode, with temperature sweep from −193° K to 423° K with a temperature ramp of 5° K/min).

A varnish composition was also prepared by mixing:
50 parts by weight of poly 205 (Bluestar Silicones),
50 parts by weight of the agent Control Release RCA 251 (Bluestar Silicones).

The varnish composition was line coated at 100 m/min on one of the faces of the backing film in the normal conditions familiar to a person skilled in the art, and crosslinked using a 200 W/cm mercury lamp, to obtain a dry deposit of 1 g/m², equivalent to a thickness of 1 micron. Then the adhesive composition was coated, still in line, on the other face of the backing film in the normal conditions familiar to a person skilled in the art, to obtain a dry deposit of 8 g/m², equivalent to a thickness of 8 microns.

### Comparative Example 4: Adhesive Film Consisting of a Rubber-Coated Three-Layer Backing

The protocol of example 4 was repeated but using a composition of the polyvinyl octadecyl type as varnish, to obtain a dry deposit of 0.05 g/m², equivalent to a thickness of 0.05 micron.

The properties of the films of example 4 and comparative example 4 are presented in Table 3.

TABLE 3

| | Example 4 | Comp. Ex. 4 |
|---|---|---|
| Deposit (g/m²) | 1 | 0.05 |
| Noise (dB) at 100 m/min | 80 | 96 |
| on 200 mm width | | |
| PAL/A 5001 (cN/cm) | 130 | 115 |

The pressure-sensitive adhesive film of example 4 has an initial detaching force PAL/A 5001 comparable to the control (measurement as indicated in example 2). The noise during unwinding of the rolls was measured at an unwinding speed of 100 m/min (roll with 200 mm width) using a CIRRUS Optimus CR 162C sound-level meter. A marked reduction in noise is found for the film according to the invention: 80 dB for the adhesive film of example 4 against 96 dB for the control roll (comparative example 4).

### Example 5: Adhesive Film Consisting of a Rubber-Coated Three-Layer Backing

A blue film with a thickness of 67 μm was prepared using equipment for three-layer blown film co-extrusion. Thus, the following were introduced:
in extruder No, 1, a 98/2 mixture by weight of radical polyethylene with a density of 0.924 and a melt flow index of 0.7 and an antiblocking masterbatch ABPE 50N (Polytechs);
in extruder No. 2, a 93/5/2 mixture by weight of radical polyethylene with a density of 0.924 and a melt flow index of 0.7, a blue colorant, Polybatch blue 4025 (A. Schulman) and Polybatch UV1952 antioxidant (A. Schulman); and
in extruder No. 3, a 98/2 mixture by weight of radical polyethylene with a density of 0.924 and a melt flow index of 0.7, and an antiblocking masterbatch ABPE 50N (Polytechs).

An extrusion aid, the “processing aids” masterbatch POLYBATCH® NATURAL AMF 705 HF (A. Schulman), was used in order to facilitate extrusion.

The extruded film thus obtained has a thickness of 67 μm and a gloss of 70 as measured according to standard ASTM2457. The surfaces intended to be in contact with the adhesive layer and the varnish layer were then corona treated.

In addition, an adhesive composition was prepared by mixing, in gasoline:
48 wt % of natural rubber (Mooney viscosity 45),
33 wt % of tackifying resin C5,
12 wt % of a paraffin oil as plasticizer,
1.5 wt % of antioxidant,
1.5 wt % of antiaging agent,
4 wt % of isocyanate crosslinking agent,
   the composition thus obtained having a glass transition temperature equal to 243° K, determined by DMA (ARES system in plate-plate mode, with temperature sweep from −193° K to 423° K with a temperature ramp of 5° K/min).

A varnish composition was also prepared by mixing:
100 parts by weight of poly 204 (Bluestar Silicones),
1 part by weight of cata 243 photoinitiator (Bluestar Silicones).

The varnish composition was coated in line before the adhesive at 100 m/min, on the backing film in the normal conditions familiar to a person skilled in the art, and crosslinked using a 200 W/cm mercury lamp, to obtain a dry deposit of 0.6 g/m², equivalent to a thickness of 0.6 microns.

The adhesive composition was coated on the backing film in the normal conditions familiar to a person skilled in the art, to obtain a dry deposit of 8 g/m², equivalent to a thickness of 8 microns.

### Comparative Example 5: Adhesive Film Consisting of a Rubber-Coated Three-Layer Backing

The protocol of example 5 was repeated but using a composition of the polyvinyl octadecyl carbamate type as the varnish, to obtain a dry deposit of 0.05 g/m², corresponding to a thickness of 0.05 micron.

The properties of the films of example 5 and comparative example 5 are presented in Table 4.

TABLE 4

| | Example 5 | Comp. Ex. 5 |
|---|---|---|
| Deposit (g/m²) | 0.6 | 0.05 |
| Noise (dB) at 100 m/min | 77 | 95 |
| on 200 mm width | | |
| PAL/A 5001 (cN/cm) | 130 cN/cm | 115 cN/cm |

The pressure-sensitive adhesive film has an initial detaching force PAL/A 5001 comparable to the control (measurement as indicated in example 2). The noise during unwinding of the rolls was measured at an unwinding speed of 100 m/min (roll with 200 mm width) using a CIRRUS Optimus CR 162C sound-level meter. A marked reduction in noise is found for the films according to the invention: 77 dB for the adhesive film of example 5 against 95 dB for the control roll (comparative example 5).

### Example 6: Adhesive Film Consisting of a Rubber-Coated Three-Layer Backing

A black/white film with a thickness of 87 μm was prepared using equipment for three-layer blown film co-extrusion. Thus, the following were introduced:
in extruder No. 1, a 90/10 mixture by weight of radical polyethylene with a density of 0.924 and a melt flow index of 0.7 and an antiblocking masterbatch ABPE 50N (Polytechs);
in extruder No. 2, an 82/16/2 mixture by weight of radical polyethylene with a density of 0.924 and a melt flow index of 0.7, a white colorant (TiO₂), CL8000 (A. Schulman), and Polybatch UV1952 antioxidant (A. Schulman); and
in extruder No. 3, an 86/12/2 mixture by weight of radical polyethylene with a density of 0.924 and a melt flow index of 0.7, a black colorant (carbon black), 1423HF1 (A. Schulman), and an antiblocking masterbatch ABPE 50N (Polytechs).

An extrusion aid, the “processing aids” masterbatch POLYBATCH® NATURAL AMF 705 HF (A. Schulman), was used in order to facilitate extrusion.

The extruded film thus obtained has a thickness of 87 μm, and a gloss of 50 measured according to standard ASTM2457. The surfaces intended to be in contact with the adhesive layer and the varnish layer were then corona treated.

In addition, an adhesive composition was prepared by mixing, in gasoline:
24 wt % of natural rubber (Mooney viscosity 45),
24 wt % of synthetic rubber SIBS,
24 wt % of tackifying resin C5,
21 wt % of a paraffin oil as plasticizer,
1.5 wt % of antioxidant,
1.5 wt % of antiaging agent,
4 wt % of isocyanate crosslinking agent.

The composition thus obtained has a glass transition temperature equal to 240° K, determined by DMA (ARES system in plate-plate mode, with temperature sweep from −193° K to 473° K with a temperature ramp of 5° K/min) and an elastic modulus G′, measured at 20° C., equal to 7.5×10⁴ Pa.

A varnish composition was also prepared by mixing:
40 parts by weight of poly 204 (Bluestar Silicones),
40 parts by weight of poly 201 (Bluestar Silicones),
10 parts by weight of Control Release RCA 251 agent (Bluestar Silicones),
10 parts by weight of Control Release RCA 200 agent (Bluestar Silicones),
3 parts by weight of cata 211 photoinitiator (Bluestar Silicones).

The varnish composition was line coated at 100 m/min on one of the faces of the backing film in the normal conditions familiar to a person skilled in the art, and crosslinked using a 200 W/cm mercury lamp, to obtain a dry deposit of 1 g/m², equivalent to a thickness of 1 micron. Then the adhesive composition was coated, still in line, on the other face of the backing film in the normal conditions familiar to a person skilled in the art, to obtain a dry deposit of 12 g/m², equivalent to a thickness of 12 microns.

### Comparative Example 6: Adhesive Film Consisting of a Rubber-Coated Three-Layer Backing

The protocol of example 6 was repeated but using a composition of the polyvinyl octadecyl type as varnish, to obtain a dry deposit of 0.05 g/m², equivalent to a thickness of 0.05 micron.

The properties of the films of example 6 and comparative example 6 are presented in Table 5.

TABLE 5

| | Example 6 | Comp. Ex. 6 |
|---|---|---|
| Deposit (g/m²) | 1 | 0.05 |
| Noise (dB) at 100 m/min | 81 | 100 |
| on 2500 mm width | | |
| PAL/A 5001 (cN/cm) | 100 cN/cm | 100 cN/cm |

The pressure-sensitive adhesive film of example 6 has an initial detaching force PAL/A 5001 comparable to the control (measurement as indicated in example 2). The noise during unwinding of the rolls was measured at an unwinding speed of 100 m/min (roll with 2500 mm width and length of 1000 m) using a CIRRUS Optimus CR 162C sound-level meter. A marked reduction in noise is found for the film according to the invention: 81 dB for the adhesive film of example 6 against 100 dB for the control roll (comparative example 6), the ambient noise in the workshop being 72 dB before unwinding the rolls.

1-11. (canceled)

12. A method for temporarily protecting a metal surface comprising:
a) unwinding a pressure-sensitive adhesive film from a roll having a width from 950 mm to 2700 mm;
b) applying the pressure-sensitive adhesive film onto the metal surface;
wherein the pressure-sensitive adhesive film comprises:
a backing comprising at least one layer of polyolefin,
a rubber adhesive coated on one of the faces of the backing,
a varnish based on epoxy-modified silicone coated on the other face of said backing,
said rubber adhesive having a glass transition temperature (Tg) above 230° K and being obtained by mixing about 5 to 40 wt % (dry extract) of a formulation containing:
30 to 80 wt % of a natural rubber or of a mixture of natural rubber(s) and synthetic rubber(s), wherein the mixture comprises at least 50 wt % of natural rubber(s);
5 to 60 wt % of one or more tackifying resin(s);
0 to 40 wt % of a plasticizer;
>0 to 6 wt % of a crosslinking agent;
0 to 4 wt % of one or more antiaging agent(s);
in a hydrocarbon-containing solvent, it being understood that the sum of the various constituents of the formulation is equal to 100 wt %;
wherein the varnish comprises:
100 parts by weight of silicone epoxy resin;
0-150 parts by weight of an adherence modulating system;
>0-20 parts by weight of a cationic photoinitiator;
0-20 parts by weight of one or more additives selected from the group consisting of: an antifoaming agent and fillers that improve sliding, abrasion resistance, and/or bonding of the varnish on the backing film;
a presence of the varnish in the pressure-sensitive adhesive film causing a reduction in unwinding force during the unwinding step a).

13. The method of claim 12, wherein the polyolefin constituting at least one layer of the backing is selected from a radical low-density polyethylene, a linear polyethylene, a polypropylene, a copolymer of ethylene and propylene, or a mixture of these compounds.

14. The method of claim 12, wherein said at least one layer of polyolefin comprises one or more additives selected from flatting agents, in particular antiblocking agents; glidants; colorants; UV stabilizers; UV barriers; antioxidants; antiaging agents.

15. The method of claim 12, wherein the varnish is coated on the backing at a rate from about 0.1 to about 5 g/m².

16. The method of claim 15, wherein the varnish is coated on the backing at a rate from about 0.5 to about 1.5 g/m².

17. The method of claim 12, wherein the rubber adhesive has an elastic modulus G′ which, measured at 1 Hz over a temperature range from 0° C. to 50° C., has values less than or equal to 3·10⁵ Pa.

18. The method of claim 12, wherein the rubber adhesive is coated on the backing at a rate from about 0.5 to about 25 g/m².

19. The method of claim 18, wherein the rubber adhesive is coated on the backing at a rate from about 2 to about 20 g/m².

20. The method of claim 12, wherein the metal of the metal surface is selected from the group consisting of: steel, aluminum and aluminum alloy.

21. The method of claim 18, wherein steel is stainless steel.

22. The method of claim 12, wherein the rubber adhesive is obtained by mixing about 5 to 40 wt % (dry extract) of a formulation containing:
35 to 75 wt % of a natural rubber or of a mixture of natural rubber(s) and synthetic rubber(s), wherein said mixture comprises at least 50 wt % of natural rubber(s);
20 to 60 wt % of one or more tackifying resin(s);
0 to 20 wt % of a plasticizer;
>0 to 4 wt % of a crosslinking agent;
0 to 2 wt % of one or more antiaging agent(s);
in a hydrocarbon-containing solvent, it being understood that the sum of the various constituents of the formulation is equal to 100 wt %.

23. The method of claim 12, wherein the backing is a multilayer backing.

24. The method of claim 23, wherein the backing has an odd number of layers, and the middle layer essentially consists of at least one polyolefin selected from the group consisting of: a radical low-density polyethylene, a linear polyethylene, a polypropylene, a copolymer of ethylene and propylene, and mixtures of these compounds.

25. The method of claim 23, wherein at least one layer of the backing comprises radical low-density polyethylene.

26. The method of claim 23, wherein all the layers of the backing comprises radical low-density polyethylene.

27. The method of claim 12, wherein the formulation of the rubber adhesive contains 30 to 80 wt % of a natural rubber.

28. The method of claim 12, wherein the formulation of the rubber adhesive contains 30 to 80 wt % of a mixture of natural rubber(s) and synthetic rubber(s), wherein said mixture comprises at least 50 wt % of natural rubber(s).

29. The method of claim 12, wherein the varnish comprises 0-50 parts by weight of an adherence modulating system.

30. The method of claim 12, further comprising removing the pressure-sensitive adhesive film from the metal surface.
